(19) United States
(12) Patent Application Publication
(10) Pub. No.: US 2026/0279963 A1
(43) Pub. Date: Sep. 17, 2026

(54) TRACTION BATTERY PACK THERMAL MANAGEMENT SYSTEM WITH COOLANT REDIRECTION

(71) Applicant: Ford Global Technologies, LLC, Dearborn, MI (US)

(72) Inventors: Xiaogang Zhang, Novi, MI (US); Jie Deng, Novi, MI (US); Yonghua Li, Ann Arbor, MI (US); James Alfred Hilditch, Canton, MI (US)

(21) Appl. No.: 19/076,815

(22) Filed: Mar. 11, 2025

(51) Int. Cl. H01M 10/6568; B60L 50/64; H01M 10/613; H01M 10/625; H01M 10/63; H01M 10/647; H01M 50/211; H01M 50/249

(52) U.S. Cl. CPC H01M 10/6568; B60L 50/64; H01M 10/613; H01M 10/625; H01M 10/63; H01M 10/647; H01M 50/211; H01M 50/249; H01M 2220/20

(57) ABSTRACT

A battery pack thermal management system includes a traction battery pack including one or more battery arrays within an enclosure assembly. The battery arrays each include battery cells. The system further includes an immersion thermal management system that communicates a liquid coolant through the enclosure assembly along a first path. The immersion thermal management system is configured to transition in response to an event to redirect the liquid coolant through the enclosure assembly along a second path instead of the first path. The second path is different than the first path.

### TECHNICAL FIELD

This disclosure details a thermal management system that can communicate a liquid coolant through areas of a traction battery pack to manage thermal energy and, more particularly, to a system that can redirect the liquid coolant in response to an event.

### BACKGROUND

Electrified vehicles differ from conventional motor vehicles because electrified vehicles include a drivetrain having one or more electric machines, which can drive the electrified vehicles instead of, or in addition to, an internal combustion engine. A traction battery pack assembly can power the electric machines. As part of a thermal management system, liquid coolant can be moved through the traction battery pack to help manage thermal energy within the traction battery pack. Some thermal management systems are immersion thermal management systems.

### SUMMARY

In some aspects, the techniques described herein relate to a battery pack thermal management system, including: a traction battery pack including one or more battery arrays within an enclosure assembly, the one or more battery arrays each including a plurality of battery cells; and an immersion thermal management system that communicates a liquid coolant through the enclosure assembly along a first path, the immersion thermal management system configured to transition in response to an event to redirect the liquid coolant through the enclosure assembly along a second path instead of the first path, the second path different than the first path.

In some aspects, the techniques described herein relate to a battery pack thermal management system, wherein the event includes a voltage change.

In some aspects, the techniques described herein relate to a battery pack thermal management system, wherein the event includes a pressure change.

In some aspects, the techniques described herein relate to a battery pack thermal management system, wherein the event includes a charging of the plurality of battery cells of the one or more battery arrays.

In some aspects, the techniques described herein relate to a battery pack thermal management system, wherein the event includes detecting that one or more battery cells within the plurality of battery cells is venting.

In some aspects, the techniques described herein relate to a battery pack thermal management system, wherein the immersion thermal management system is configured to transition in response to the event and in response to a location of the event within the enclosure assembly.

In some aspects, the techniques described herein relate to a battery pack thermal management system, wherein the liquid coolant moves through the enclosure assembly along the first path in a first direction, wherein the liquid coolant moves through the enclosure assembly along the second path in a second direction, the second direction is opposite the first direction.

In some aspects, the techniques described herein relate to a battery pack thermal management system, further including at least one valve that is actuated in response to the event to direct the liquid coolant along the second path instead of the first path.

In some aspects, the techniques described herein relate to a battery pack thermal management system, wherein the at least one valve includes a first valve associated with at least one first port of the traction battery pack, and a second valve associated with at least one second port of the traction battery pack.

In some aspects, the techniques described herein relate to a battery pack thermal management system, the first valve configured to transition in response to the event from a state where the first valve permits a flow of the liquid coolant through the at least one first port into the enclosure assembly to a state where the first valve blocks the flow of the liquid coolant through the at least one first port into the enclosure assembly, the second valve configured to transition in response to the event from a state where the second valve permits the flow of the liquid coolant through the at least one second port from the enclosure assembly to a state where the second valve blocks the flow of the liquid coolant through the at least one second port from the enclosure assembly.

In some aspects, the techniques described herein relate to a battery pack thermal management system, wherein the first valve is a first three-way valve, and the second valve is a second three-way valve.

In some aspects, the techniques described herein relate to a battery pack thermal management system, wherein the at least one valve is configured to transition from a first state to a second state in response to the event, wherein the liquid coolant moves to the enclosure assembly through at least one first port and exits the enclosure assembly through at least one second port when the at least one valve is in the first state, wherein the liquid coolant moves to the enclosure assembly through the at least one second port and exits the enclosure assembly through the at least one first port when the at least one valve is in the second state.

In some aspects, the techniques described herein relate to a battery pack thermal management system, wherein the liquid coolant moves through the enclosure assembly along the first path in a first direction when the at least one valve is in the first state, wherein the liquid coolant moves through the enclosure assembly along the second path in a second direction when the at least one valve is in the second state, the second direction opposite the first direction.

In some aspects, the techniques described herein relate to a battery pack thermal management system, wherein the at least one valve is a five-way valve.

In some aspects, the techniques described herein relate to a battery pack thermal management system, wherein the at least one valve is outside the enclosure assembly.

In some aspects, the techniques described herein relate to a battery pack thermal management system, including: a traction battery pack including one or more battery arrays within an enclosure assembly, the one or more battery arrays each including a plurality of battery cells; and a liquid coolant redirecting system configured to transition from a first state to a second state in response to a thermal event associated with the one or more battery arrays, wherein liquid coolant moves through the enclosure assembly in a first direction when the liquid coolant redirecting system is in the first state, wherein liquid coolant moves through the enclosure assembly in a second direction when liquid coolant redirecting system is in the second state, the second direction different from the first direction.

In some aspects, the techniques described herein relate to a battery pack thermal management system, wherein the liquid coolant is a dielectric immersion thermal management fluid.

In some aspects, the techniques described herein relate to a battery pack thermal management system, wherein, when the liquid coolant redirecting system is in the first state, liquid coolant enters the enclosure assembly through at least one first port and exits the enclosure assembly through at least one second port, wherein, when the liquid coolant redirecting system is in the second state, liquid coolant enters the enclosure assembly through the at least one second port and exits the enclosure assembly through the at least one first port.

In some aspects, the techniques described herein relate to a battery pack thermal management system, wherein the thermal event includes detecting that one or more battery cells within the plurality of battery cells is venting.

In some aspects, the techniques described herein relate to a battery pack thermal management system, wherein the thermal event is associated with one or more of the battery cells within the plurality of battery cells, wherein the liquid coolant redirecting system is configured to transition from the first state to the second state in response to the thermal event and in response to a location of the thermal event within the traction battery pack.

The embodiments, examples and alternatives of the preceding paragraphs, the claims, or the following description and drawings, including any of their various aspects or respective individual features, may be taken independently or in any combination. Features described in connection with one embodiment are applicable to all embodiments unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack.

FIG. 2 illustrates a perspective view of the battery pack of FIG. 1.

FIG. 3 illustrates an expanded view of the battery pack of FIG. 2.

FIG. 4 illustrates a schematic view of a thermal management system and the battery pack of FIGS. 2 and 3 when the thermal management system is in a first operational state.

FIG. 5 illustrates the battery pack and system of FIG. 4 after transitioning the system to a second operational state in response to an event.

### DETAILED DESCRIPTION

Thermal management systems, such as immersion thermal management systems, can be used to manage thermal energy in a traction battery pack. In an immersion thermal management system, at least some components of the traction battery pack are submerged in a liquid coolant. The submerged components can include battery arrays and their battery cells.

This disclosure is directed toward a system that can alter how liquid coolant is moved through the traction battery pack in response to an event, such as a thermal event. During a thermal event, one or more battery cells can discharge vent byproducts into the liquid coolant. Redirecting the coolant can move the vent byproducts out of the battery pack along a relatively short path. This can reduce a number of battery cells and other components that are exposed to vent byproducts. Redirecting the liquid coolant can also instead or additionally be utilized to reduce a thermal gradient within the traction battery pack.

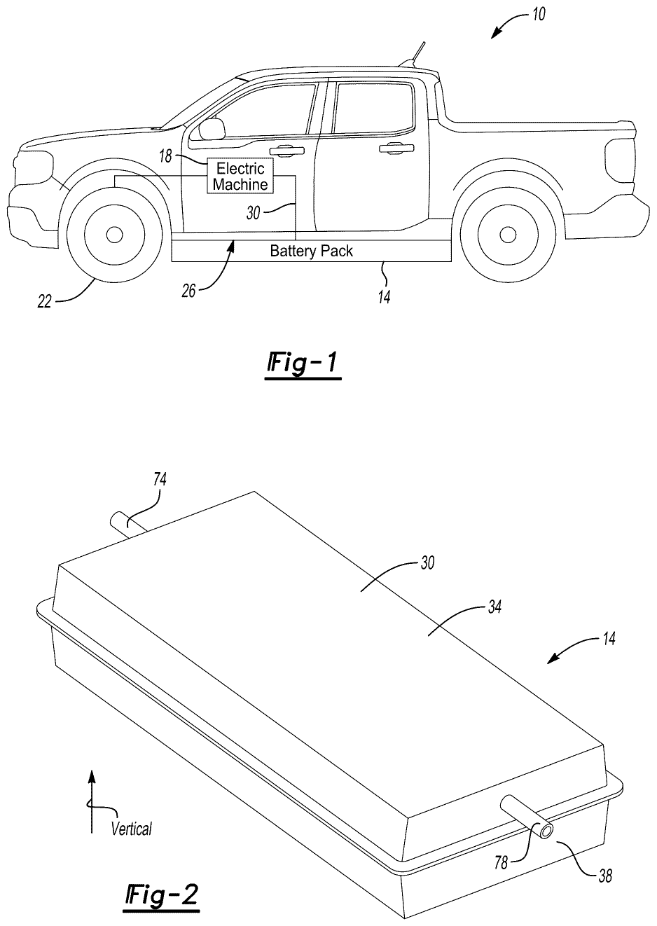

With reference to FIG. 1, an electrified vehicle 10 includes a traction battery pack 14, an electric machine 18, and wheels 22. The traction battery pack 14 powers an electric machine 18, which can convert electrical power to mechanical power to drive the wheels 22. The traction battery pack 14 can be a relatively high-voltage battery.

The traction battery pack 14 is, in the exemplary embodiment, secured to an underbody 26 of the electrified vehicle 10. The traction battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

Although the different examples have the specific components shown in the illustrations, embodiments of this disclosure are not limited to those combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

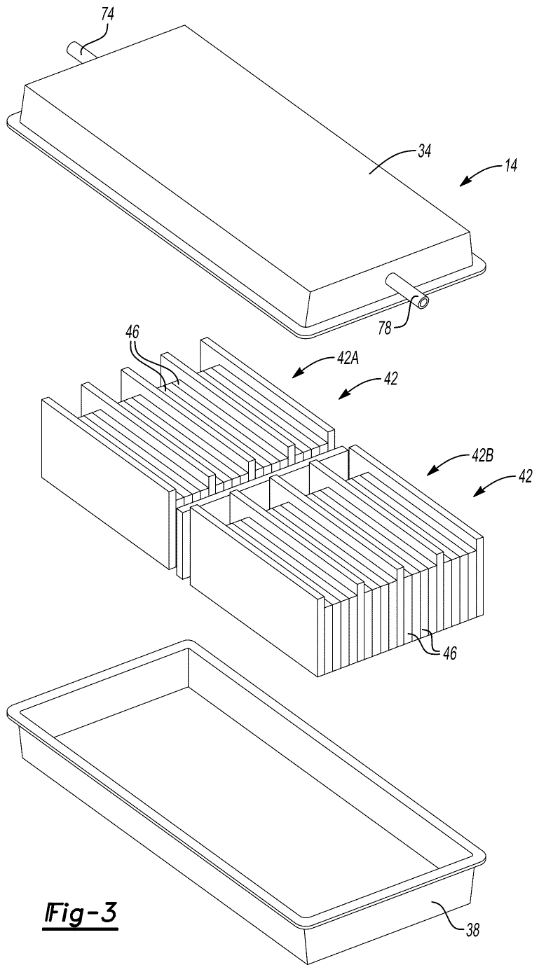

FIGS. 2-4 illustrate additional detail of the example battery pack 14. In this example, the battery pack 14 includes an enclosure assembly 30 having enclosure structures—here a cover 34 and a tray 38. The cover 34, in this example, is vertically above the tray 38. In other examples, however, the cover 34 could be arranged below, or to a side of the tray 38.

Various terms such as “vertical,” “above,” “below,” “top,” and “bottom” are used relative to the arrangement of the components of the battery pack 14 in the various drawings and should not otherwise be deemed limiting. These terms are with reference to the general orientation of the battery pack 14 when installed within the vehicle 10 of FIG. 1,

The cover 34 is welded to the tray 38 in one example of this disclosure. While welding is mentioned, the cover 34 and tray 38 could be connected using other fluid-tight connection techniques, such as adhesive. While an exemplary enclosure assembly 30 is shown in the drawings, the enclosure assembly 30 may vary in size, shape, and configuration within the scope of this disclosure.

The battery pack 14 includes one or more battery arrays 42 housed within the enclosure assembly 30. Each of the battery arrays 42 includes a plurality of individual battery cells disposed along a respective array axis. The battery arrays 42 could include any number of individual battery cells 46. In the exemplary embodiment, the battery pack 14 includes a first battery array 42a alongside a second battery array 42b. The battery pack 14, however, could employ any number of the battery arrays 42 within the enclosure assembly 30. Thus, this disclosure is not limited to the exact configuration shown in FIGS. 2-4.

In the exemplary embodiment, the battery cells 46 are pouch-style, lithium-ion cells. However, battery cells having other geometries (cylindrical, prismatic, etc.), other chemistries (nickel-metal hydride, lead-acid, etc.), or both could alternatively be utilized within the scope of this disclosure.

The arrays 42 are arranged within the interior of the enclosure assembly 30 between the tray 38 and the cover 34. A thermal management system 50 is relied on to manage thermal energy levels within the battery pack 14. The example thermal management system 50 is an immersion-based thermal management system that is configured to route non-conductive (i.e., dielectric) liquid coolant C through the interior of the enclosure assembly 30. Within the interior of the enclosure assembly 30, components can be submerged within the liquid coolant C. The liquid coolant C can take on thermal energy from the cells 46 of the arrays 42 and from other components of the traction battery pack 14. The liquid coolant C with the thermal energy from the components is then communicated away from the battery pack 14. The example liquid coolant C can be a dielectric liquid coolant.

Within the interior of the enclosure assembly 30, the liquid coolant C can pass over a vertical top of the battery arrays 42, beneath the battery arrays 42, and alongside the battery arrays 42. Thermal energy can, for example, move from the battery cells 46 to the liquid coolant C as the liquid coolant C is moved through the interior of the enclosure assembly 30. The liquid coolant C is then moved from the battery pack 14 to communicate thermal energy from the battery pack 14 and cool the battery pack 14.

In this example, the liquid coolant C can be used to cool the battery cells 46 and other components. In some examples, the liquid coolant C can be used to heat the battery cells 46 and other components.

In the exemplary embodiment, the coolant system 50 includes a pump 52, a coolant reservoir 54, a chiller 58, a liquid gas separator 62, a first valve 66, and a second valve 70. When the thermal management system 50 is in a first operational state, which is during ordinary operation, the liquid coolant C flows along a first path where pump 52 pumps liquid coolant C drawn from the coolant reservoir 54 through the first valve 66 and into the enclosure assembly 30 through a first port 74. The liquid coolant C moves through the interior of the enclosure assembly 30 in a first direction D1 over the components of the first array 42A and then over the components of the second array 42B. The liquid coolant C, which has taken thermal energy from the components within the interior, exits from the enclosure assembly through a second port 78.

When the coolant C moves through the enclosure assembly 30 in the direction D1, the battery array 42A and its battery cells 46 are upstream from the battery array 42B and its battery cells 46. That is, coolant C that passes over the battery array 42B is coolant C that has already passed over the battery array 42A.

From the second port 78, the coolant C moves through the second valve 70 to the liquid gas separator 62, and then through a chiller 58. From the chiller 58, the liquid coolant C is directed back into the coolant reservoir 54. From the coolant reservoir 54, the liquid coolant C can be pumped back through the first valve 66, through the first port 74, and into the interior of the enclosure assembly 30. The coolant C continues to circulate through the enclosure assembly 30 along the first path during typical operation of the battery pack 14 and thermal management system 50.

In the exemplary embodiment, the thermal management system 50 additionally includes a control module 82 that is operatively connected to one or more sensors 86. The control module 82 is also operatively connected to the first valve 66 and the second valve 70.

The control module 82 can be part of larger module within the vehicle 10. The control module 82, in this example, includes a processor operatively linked to a memory portion. The example processor can be programmed to execute a program stored in the memory portion. The program may be stored in the memory portion as software code. The program stored in the memory portion may include one or more additional or separate programs, each of which includes an ordered list of executable instructions for implementing logical functions associated with obtaining information from sensors 86 and controlling the first valve 66 and the second valve 70.

The processor can be a custom made or commercially available processor, a central processing unit (CPU), an auxiliary processor among several processors associated with the control module, a semiconductor-based microprocessor (in the form of a microchip or chip set) or generally any device for executing software instructions.

The memory portion can include any one or combination of volatile memory elements and/or nonvolatile memory elements. The memory may incorporate electronic, magnetic, optical, and/or other types of storage media.

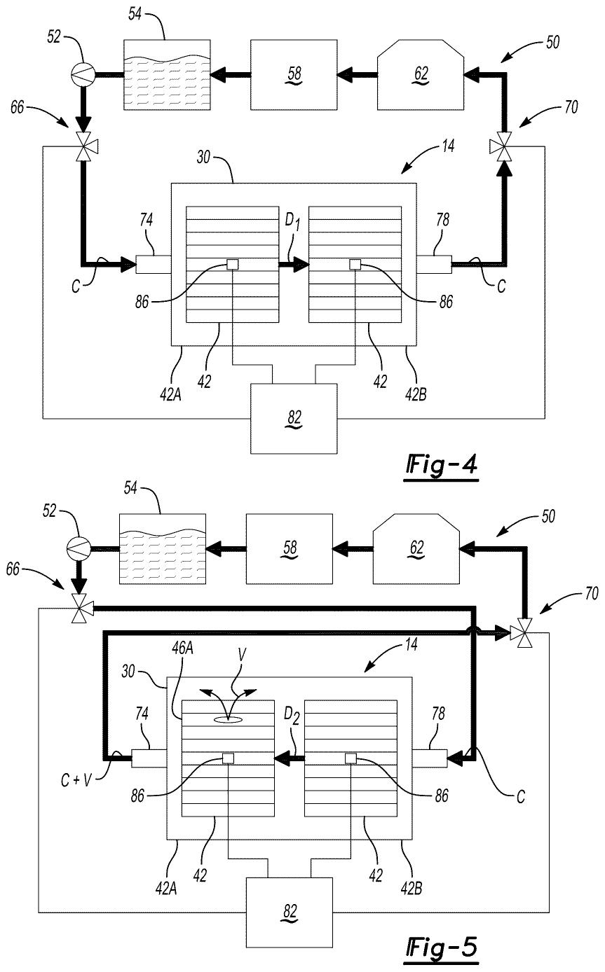

In the exemplary embodiment the sensors 86 can monitor voltage associated with each individual one of the battery cells 46 within the battery pack 14. The control module 82 can receive voltage information from the sensors 86 and maintain a positioning of the first valve 66 and the second valve 70 to continue to communicate the liquid coolant C through the enclosure assembly 30 along a first path as shown in FIG. 4.

While two sensors 86 are schematically shown, individual sensors 86 can be associated with individual groups of one or more battery cells 46. The sensors 86 can provide location information to the control module 82 so that the control module 82 can assess where the event is occurring within the interior of the battery pack 14.

The thermal management system 50 is configured to actuate the first valve 66 and the second valve 70 in response to an event to change how the liquid coolant moves through the enclosure assembly 30.

An example event can be a thermal event where one or more battery cells 46 begin to discharge vent byproducts from the interior of that battery cell 46 into the liquid coolant C within the interior of the enclosure assembly 30. The exemplary thermal management system is configured to selectively transition the first valve 66 and the second valve 70 in response to such an event to redirect the coolant C to flow along a different, second path instead of the first path.

With reference now to FIG. 5, and continuing reference to FIG. 4, FIG. 5 shows a schematic view of the thermal management system 50 and the battery pack 14 after the system 50 has transitioned from the first operational state shown in FIG. 4 where the coolant C moves through the interior of the enclosure assembly 30 in a direction D1, to a second operational state where the coolant C moves through the interior of the enclosure assembly 30 in a direction D2. When the coolant C moves through the enclosure assembly 30 in the direction D2, the enclosure assembly 30 receives the liquid coolant C through the second port 78, and the liquid coolant C exits the enclosure assembly 30 through the first port 74. The liquid coolant C, after exiting from the enclosure assembly 30 through the first port 74, continues to flow along a second path back through the second valve 70 to the liquid gas separator 62, the chiller 58, and into the coolant reservoir 54. The coolant C can then, if required, be pumped from the coolant reservoir 54 through the first valve 66 and into the enclosure assembly 30 through the second port 78.

In the exemplary embodiment, the control module 82 received information from the one or more of the sensors 86 indicating that one or more of the battery cells 46 is experiencing a thermal event. In the exemplary embodiment, a cell 46A in the array 42A is experiencing the event detected by one or more of the sensors 86. Reversing the direction of flow of coolant C through the interior of the enclosure assembly 30 moves the liquid coolant C through the enclosure 30 in an opposite direction such that the venting battery cell 46A and its vent byproducts V are downstream from the array 42B. Thus, at least the cells 46 within the array 42B are less exposed to the vent byproducts V after the thermal management system 50 has transitioned from the first operational state to the second operational state. Limiting exposure of the battery cells 46 to the vent byproducts V can help to inhibit the thermal event from cascading to other battery cells 46.

The first valve 66 and the second valve 70 are three-way valves in this example. The control module 82 can actuate the first valve 66 and the second valve 70 to selectively block or permit flow. In another example more than two valves could be used to redirect the flow of the liquid coolant C. In addition, a single five-way valve could be used in place of the first valve 66 and the second valve 70.

The first valve 66 and the second valve 70 are configured to transition in response to a command from the control module 82, which can issue the command in response to detection of an event, here the thermal event. In the exemplary embodiment, the event is detected based on a voltage change indicating that one or more of the battery cells 46A is venting or experiencing a thermal event. If, for example, one of the battery cells 46 in the array 42B were experiencing the event rather than the cell 46A in the first array 42A, the control module 82 would maintain the coolant C to move in the direction D1 and may not transition the first valve 66 or the second valve 70. As can be appreciated, the battery cell 46 within the battery array 42B that starts to discharge vent byproducts would be downstream from the cells 46 of the battery array 42A relative to the direction D1 of the flow of liquid coolant C through the interior of the enclosure assembly 30.

In this example the sensors 86 are detecting voltage, and likely a voltage drop, to assess whether an event necessitating a transition or redirection of the coolant C is needed. In other examples, the event could be a pressure change (e.g., pressure spike) and the sensors 86 could comprise pressure sensors. The sensors 86 could instead or additionally comprise temperature sensors. The control module 82 can rely on the temperature measurements to assess whether or not an event has occurred necessitating redirecting the coolant C within the interior.

Events other than thermal events and factors other than voltage changes could trigger a redirection of the coolant C through the interior of the battery pack 14. For example, the control module 82 may periodically transition the first valve 66 and the second valve 70 to change the direction of coolant C moving through the interior to reduce a thermal gradient within the battery pack 14.

The control module 82 could also rely on an event such as a charging event to trigger a redirection of flow to the interior of the enclosure assembly 30. The control module 82 could, for example, actuate the first valve 66 and the second valve 70 to change the path of coolant C from the first path shown in FIG. 4 to the second path shown in FIG. 5 when the user begins a fast charge of the battery cells 46 within the battery pack 14. After the fast charge is complete, the control module 82 could transition the first valve 66 and the second valve 70 back to a position where the coolant C moves along the first path shown in FIG. 4. Periodically changing the direction of flow of the liquid coolant C can reduce a thermal gradient as each of the arrays 42 can periodically receive liquid coolant C that has not passed over, and taken on thermal energy from, the other of the arrays 42.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack thermal management system, comprising:
a battery pack including one or more battery arrays within an enclosure assembly, the one or more battery arrays each including a plurality of battery cells; and
an immersion thermal management system that communicates a liquid coolant through the enclosure assembly along a first path, the immersion thermal management system configured to transition in response to an event to redirect the liquid coolant through the enclosure assembly along a second path instead of the first path, the second path different than the first path.

2. The battery pack thermal management system of claim 1, wherein the event comprises a voltage change.

3. The battery pack thermal management system of claim 1, wherein the event comprises a pressure change.

4. The battery pack thermal management system of claim 1, wherein the event comprises a charging of the plurality of battery cells of the one or more battery arrays.

5. The battery pack thermal management system of claim 1, wherein the event comprises detecting that one or more battery cells within the plurality of battery cells is venting.

6. The battery pack thermal management system of claim 1, wherein the immersion thermal management system is configured to transition in response to the event and in response to a location of the event within the enclosure assembly.

7. The battery pack thermal management system of claim 1, wherein the liquid coolant moves through the enclosure assembly along the first path in a first direction, wherein the liquid coolant moves through the enclosure assembly along the second path in a second direction, the second direction is opposite the first direction.

8. The battery pack thermal management system of claim 1, further comprising at least one valve that is actuated in response to the event to direct the liquid coolant along the second path instead of the first path.

9. The battery pack thermal management system of claim 8, wherein the at least one valve includes a first valve associated with at least one first port of the battery pack, and a second valve associated with at least one second port of the battery pack.

10. The battery pack thermal management system of claim 9, the first valve configured to transition in response to the event from a state where the first valve permits a flow of the liquid coolant through the at least one first port into the enclosure assembly to a state where the first valve blocks the flow of the liquid coolant through the at least one first port into the enclosure assembly, the second valve configured to transition in response to the event from a state where the second valve permits the flow of the liquid coolant through the at least one second port from the enclosure assembly to a state where the second valve blocks the flow of the liquid coolant through the at least one second port from the enclosure assembly.

11. The battery pack thermal management system of claim 10, wherein the first valve is a first three-way valve, and the second valve is a second three-way valve.

12. The battery pack thermal management system of claim 9, wherein the at least one valve is configured to transition from a first state to a second state in response to the event, wherein the liquid coolant moves to the enclosure assembly through at least one first port and exits the enclosure assembly through at least one second port when the at least one valve is in the first state, wherein the liquid coolant moves to the enclosure assembly through the at least one second port and exits the enclosure assembly through the at least one first port when the at least one valve is in the second state.

13. The battery pack thermal management system of claim 12, wherein the liquid coolant moves through the enclosure assembly along the first path in a first direction when the at least one valve is in the first state, wherein the liquid coolant moves through the enclosure assembly along the second path in a second direction when the at least one valve is in the second state, the second direction opposite the first direction.

14. The battery pack thermal management system of claim 13, wherein the at least one valve is a five-way valve.

15. The battery pack thermal management system of claim 8, wherein the at least one valve is outside the enclosure assembly.

16. A battery pack thermal management system, comprising:
a battery pack including one or more battery arrays within an enclosure assembly, the one or more battery arrays each including a plurality of battery cells; and
a liquid coolant redirecting system configured to transition from a first state to a second state in response to a thermal event associated with the one or more battery arrays, wherein liquid coolant moves through the enclosure assembly in a first direction when the liquid coolant redirecting system is in the first state, wherein liquid coolant moves through the enclosure assembly in a second direction when liquid coolant redirecting system is in the second state, the second direction different from the first direction.

17. The battery pack thermal management system of claim 16, wherein the liquid coolant is a dielectric immersion thermal management fluid.

18. The battery pack thermal management system of claim 16, wherein, when the liquid coolant redirecting system is in the first state, liquid coolant enters the enclosure assembly through at least one first port and exits the enclosure assembly through at least one second port, wherein, when the liquid coolant redirecting system is in the second state, liquid coolant enters the enclosure assembly through the at least one second port and exits the enclosure assembly through the at least one first port.

19. The battery pack thermal management system of claim 16, wherein the thermal event comprises detecting that one or more battery cells within the plurality of battery cells is venting.

20. The battery pack thermal management system of claim 16, wherein the thermal event is associated with one or more of the battery cells within the plurality of battery cells, wherein the liquid coolant redirecting system is configured to transition from the first state to the second state in response to the thermal event and in response to a location of the thermal event within the battery pack.
